(19) United States
(12) Patent Application Publication
(10) Pub. No.: US 2026/0010346 A1
(43) Pub. Date: Jan. 8, 2026

(54) NATURE EXPONENTIAL FUNCTION COMPUTING DEVICE AND COMPUTING METHOD THEREOF

(71) Applicant: NEUCHIPS CORPORATION, Hsinchu City (TW)

(72) Inventors: Huang-Chih Kuo, Hsinchu City (TW); YuShan Ruan, New Taipei City (TW)

(73) Assignee: NEUCHIPS CORPORATION, Hsinchu City (TW)

(21) Appl. No.: 18/805,558

(22) Filed: Aug. 15, 2024

(30) Foreign Application Priority Data
Jul. 5, 2024 (TW) 113125366

(51) Int. Cl. G06F 7/556

(52) U.S. Cl. CPC G06F 7/556

(57) ABSTRACT

A nature exponential function computing device and a computing method for the nature exponential function computing device are provided. The nature exponential function computing device includes a first lookup table, a second lookup table, and an operation circuit. The first lookup table selects a first natural exponent value from first natural exponent values according to an input exponent part of an input value conforming to a floating point number format. The second lookup table selects at least one selected second natural exponent value from second natural exponent values according to the input exponent part and an input mantissa part of the input value. The operation circuit operates on the selected first natural exponent value and the at least one selected second natural exponent value to generate an output exponent part and an output mantissa part conforming to the floating point number format.

### CROSS-REFERENCE TO RELATED APPLICATION

This application claims the priority benefit of Taiwan application serial no. 113125366, filed on Jul. 5, 2024. The entirety of the above-mentioned patent application is hereby incorporated by reference herein and made a part of this specification.

### BACKGROUND

### Technical Field

The invention relates to a computing device and a computing method for the computing device, and particularly relates to a natural exponential function computing device and a computing method for performing natural exponential function computations on input values conforming to a floating point number format.

### Description of Related Art

Natural exponential functions (expressed as e^{x} or EXP(X)) are commonly used in various mathematical models, such as an activation function in AI models. The complexity of natural exponential function computations is much higher than computations of addition, subtraction, etc. Therefore, when performing natural exponential function computations, current hardware will take a long computing time and have a large circuit design cost. Therefore, how to reduce the computing time and circuit design cost required to perform the natural exponential function computations is one of the research focuses of those skilled in the art.

### SUMMARY

The invention is directed to a natural exponential function computing device and a computing method for the natural exponential function computing device, which reduce a computing time and a circuit design cost required for performing natural exponential function computations.

In an embodiment of the invention, the nature exponential function computing device for performing natural exponential function computation on an input value conforming to a floating point number format. The nature exponential function computing device includes a first lookup table, a second lookup table, and an operation circuit. The first lookup table stores a plurality of first natural exponent values, and selects a selected first natural exponent value from the plurality of first natural exponent values according to an input exponent part of the input value. The second lookup table stores a plurality of second natural exponent values, and selects at least one selected second natural exponent value from the plurality of second natural exponent values according to the input exponent part and an input mantissa part of the input value when the value of mantissa part is not zero. The plurality of second natural exponent values are generated according to different powers of a natural constant. The plurality of powers are respectively n powers of 2, where n is an integer. The operation circuit is coupled to the first lookup table and the second lookup table. The operation circuit operates on the selected first natural exponent value and the at least one selected second natural exponent value to generate an output exponent part and an output mantissa part conforming to the floating point number format.

In an embodiment of the invention, the computing method is used for the nature exponential function computing device. The nature exponential function computing device performs natural exponential function computation on an input value conforming to a floating point number format. The nature exponential function computing device includes a first lookup table, a second lookup table, and an operation circuit. The computing method includes: storing a plurality of first natural exponent values by the first lookup table, and storing a plurality of second natural exponent values by the second lookup table; selecting a selected first natural exponent value from the plurality of first natural exponent values by the first lookup table according to an input exponent part of the input value; selecting at least one selected second natural exponent value from the plurality of second natural exponent values by the second lookup table according to the input exponent part and an input mantissa part of the input value when the value of mantissa part is not zero, wherein the plurality of second natural exponent values are generated according to different powers of a natural constant, wherein the plurality of powers are respectively n powers of 2, where n is an integer; and operating on the selected first natural exponent value and the at least one selected second natural exponent value by the operation circuit to generate an output exponent part and an output mantissa part conforming to the floating point number format.

Based on the above description, the first lookup table stores a plurality of first natural exponent values. The second lookup table stores a plurality of second natural exponent values. The number of the first natural exponent values may be reduced based on the floating point number format. The number of the second natural exponent values may also be reduced based on the floating point number format. Therefore, the requirements on the storage spaces of the first lookup table and the second lookup table are reduced. In this way, the nature exponential function computing device is adapted to reduce a computing time and circuit design cost required to perform the nature exponential function computation.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a nature exponential function computing device according to an embodiment of the invention.

FIG. 2 is a schematic diagram of an input value according to an embodiment of the invention.

FIG. 3 is a schematic diagram of a second natural exponent value according to an embodiment of the invention.

FIG. 4 is a schematic diagram of a nature exponential function computing device according to an embodiment of the invention.

FIG. 5 is a flowchart of a computing method according to an embodiment of the invention.

### DESCRIPTION OF THE EMBODIMENTS

Some embodiments of the invention will be described in detail with reference to the accompanying drawings. The component symbols cited in the following description will be regarded as the same or similar components when the same component symbols appear in different drawings. These embodiments are only part of the invention and do not disclose all possible implementations of the invention. Rather, these embodiments are only examples within the scope of the patent application of the invention.

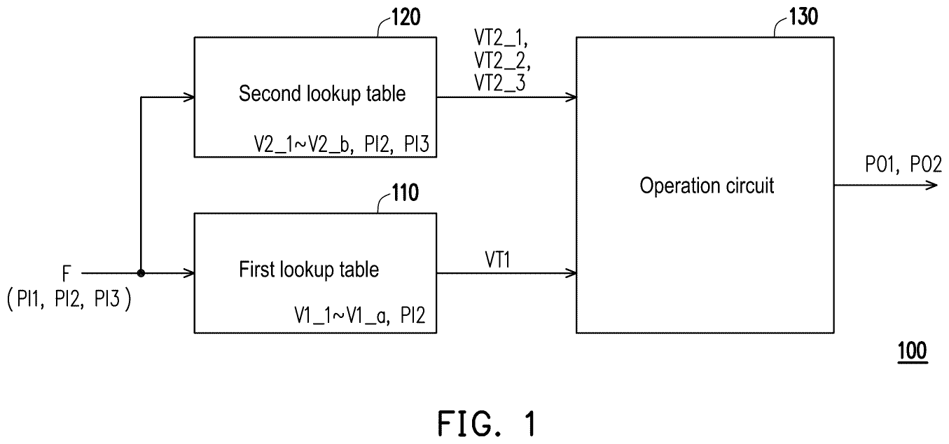

Referring to FIG. 1, FIG. 1 is a schematic diagram of a nature exponential function computing device according to an embodiment of the invention. In the embodiment, the nature exponential function computing device 100 may perform nature exponential function computing on an input value F conforming to a floating point number format. Based on the floating point number format, the input value F includes an input sign part PI1, an input exponent part PI2 and an input mantissa part PI3.

The nature exponential function computing device 100 includes a first lookup table 110, a second lookup table 120 and an operation circuit 130. The first lookup table 110 stores first natural exponent values V1_1-V1_a. The first lookup table 110 selects a selected first natural exponent value VT1 from the first natural exponent values V1_1 to V1_a according to the input exponent part PI2 of the input value F. The second lookup table 120 stores second natural exponent values V2_1-V2_b. The second lookup table 120 selects selected second natural exponent values VT2_1, VT2_2, and VT2_3 from the second natural exponent values V2_1 to V2_b according to the input exponent part PI2 and the input mantissa part PI3 of the input value F. The selected first natural exponent value VT1 is one of the first natural exponent values V1_1-V1_a. The selected second natural exponent values VT2_1, VT2_2, and VT2_3 are respectively one of the second natural exponent values V2_1-V2_b.

In the embodiment, the second natural exponent values V2_1-V2_b are generated according to a plurality of different powers of a natural constant. The plurality of powers are respectively n powers of 2 (i.e. EXP(2ⁿ)), where n is an integer. n of the second natural exponent values V2_1-V2_b are different from each other.

In the embodiment, the operation circuit 130 is coupled to the first lookup table 110 and the second lookup table 120. The operation circuit 130 operates on the selected first natural exponent value VT1 and the selected second natural exponent values VT2_1, VT2_2, and VT2_3 to generate an output exponent part PO1 and an output mantissa part PO2 conforming to the floating point number format.

It is worth mentioning here that the first lookup table 110 stores the first natural exponent values V1_1-V1_a. The second lookup table 120 stores the second natural exponent values V2_1-V2_b. A number of the first natural exponent values V1_1-V1_a may be reduced based on the floating point number format. A number of the second natural exponent values V2_1-V2_b may also be reduced based on the floating point number format. Therefore, the requirements on the storage spaces of the first lookup table 110 and the second lookup table 120 may be reduced. In this way, the nature exponential function computing device 100 may reduce the computing time and circuit design cost required to perform the nature exponential function computation.

For example, taking a positive FP32 floating point number format as an example (the invention is not limited thereto), the first lookup table 110 stores 256 first natural exponent values V1_1-V1_a. In other words, a is equal to “256”. The second lookup table 120 stores 23 second natural exponent values V2_1-V2_b for each exponent value of FP32. In other words, b is equal to “256×23=5888”. For example, the first natural exponent values V1_1-V1_a of the first lookup table 110 may be represented by equation (1).

$$V 1 = EXP ( {2}^{( EB - BS )} ) \qquad equation ( 1 )$$

“EB” is the input exponent part PI2. “BS” equals “127”.

For example, the second natural exponent value V2_1 may be expressed by equation (2). The second natural exponent value V2_2 may be expressed by equation (3). The second natural exponent value V2_3 may be expressed by equation (4), and so on.

$$V 2 \_ 1 = EXP ( {2}^{( EB - BS )} * ( \frac{1}{{2}^{23}} ) ) \qquad equation ( 2 )$$

$$V 2 \_ 2 = EXP ( {2}^{( EB - BS )} * ( \frac{2}{{2}^{23}} ) ) \qquad equation ( 3 )$$

$$V 2 \_ 3 = EXP ( {2}^{( EB - BS )} * ( \frac{4}{{2}^{23}} ) ) \qquad equation ( 4 )$$

“EB” is a value of the input exponent part PI2. “BS” equals “127”.

For example, taking the FP16 floating point number format as an example (the invention is not limited thereto), the first lookup table 110 stores 32 first natural exponent values V1_1-V1_a. In other words, a equals “32”. The first natural exponent values V1_1-V1_a of the first lookup table 110 may be expressed by equation (1). Based on the FP16 floating point number format, “BS” is equal to “15”.

The second lookup table 120 stores 10 second natural exponent values V2_1-V2_b for each exponent value of FP16. In other words, b is equal to “32×10=320”. For example, the second natural exponent value V2_1 may be represented by equation (5). The second natural exponent value V2_2 may be expressed by equation (6). The second natural exponent value V2_3 may be expressed by equation (7), and so on.

$$V 2 \_ 1 = EXP ( {2}^{( EB - BS )} * ( \frac{1}{{2}^{10}} ) ) \qquad equation ( 5 )$$

$$V 2 \_ 2 = EXP ( {2}^{( EB - BS )} * ( \frac{2}{{2}^{10}} ) ) \qquad equation ( 6 )$$

$$V 2 \_ 3 = EXP ( {2}^{( EB - BS )} * ( \frac{4}{{2}^{10}} ) ) \qquad equation ( 7 )$$

In the embodiment, the operation circuit 130 may perform multiplication operations on the selected first natural exponent value VT1 and the selected second natural exponent values VT2_1, VT2_2, and VT2_3 to generate the output exponent part PO1 and the output mantissa part PO2 conforming to the floating point number format.

For example, the operation circuit 130 performs a multiplication operation on the selected first natural exponent value VT1 and one of the selected second natural exponent values VT2_1, VT2_2, and VT2_3 in an iterative manner to generate the output exponent part PO1 and the output mantissa part PO2 conforming to the floating point number format. For further example, the operation circuit 130 performs a multiplication operation on the selected first natural exponent value VT1 and the selected second natural exponent value VT2_1 to generate a first product. The operation circuit 130 performs a multiplication operation on the first product and the selected second natural exponent value VT2_2 to generate a second product. The operation circuit 130 performs a multiplication operation on the second product and the selected second natural exponent value VT2_3 to generate a third product, and generates the output exponent part PO1 and the output mantissa part PO2 based on the third product.

A number of the selected second natural exponent values of the invention is determined based on the input exponent part PI2 and the input mantissa part PI3 of the input value F, and is not limited by the selected second natural exponent values VT2_1, VT2_2, VT2_3 of the embodiment.

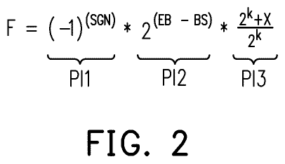

Referring to FIG. 1 and FIG. 2, FIG. 2 is a schematic diagram of an input value according to an embodiment of the invention. In the embodiment, based on the floating point number format, the input value F includes the input sign part PI1, the input exponent part PI2, and the input mantissa part PI3. The input sign part PI1 is expressed as “−1” raised to the power of “SGN”. “SGN” may be “0” or “1”. The input exponent part PI2 is expressed as “2” raised to the (EB-BS) power. The input mantissa part PI3 is expressed as an operation result of a sum of “2” raised to the “k” power and “x” divided by “2” raised to the “k” power. “x” is equal to a value of the input mantissa part PI3.

Taking the floating point number format of FP32 as an example (the invention is not limited thereto), “BS” is equal to “127”. “k” is equal to “23”. Taking the floating point number format of FP16 as an example (the invention is not limited thereto), “BS” is equal to “15”. “k” is equal to “10”.

The input value F is subjected to a nature exponential function computation as shown in equation (8).

$$EXP ( F ) = EXP ( {( - 1 )}^{SGN} * {2}^{( EB - BS )} * \frac{{2}^{k} + x}{{2}^{k}} ) \qquad equation ( 8 )$$

Equation (8) is expanded into equation (9).

$$EXP ( {( - 1 )}^{SGN} * {2}^{( EB - BS )} * \frac{{2}^{k}}{{2}^{k}} ) * EXP ( {( - 1 )}^{SGN} * {2}^{( EB - BS )} * \frac{x}{{2}^{k}} ) \qquad equation ( 9 )$$

The operation result of the nature exponential function computation does not have a negative value. Therefore, equation (9) may be simplified to equation (10).

$$EXP ( F ) = EXP ( {2}^{( EB - BS )} ) * EXP ( {2}^{( EB - BS )} * \frac{x}{{2}^{k}} ) = B * P \qquad equation ( 10 )$$

It should be noted that “B” in equation (10) is equal to the selected first natural exponent value VT1 in the first natural exponent values V1_1-V1_a.

For example, the input value F is equal to “0.251373828125”. Taking the floating point number format of FP16 as an example (the invention is not limited thereto), the input value F is represented as “0-01101-0000001101”. “0” of a 15^{th} bit is the input sign part PI1. “01101” from a 10^{th} bit to a 14^{th} bit is the input exponent part PI2. “0000001101” from 0^{th} bit to a 9^{th} bit is the input mantissa part PI3. A value of the input exponent part PI2 is equal to “13”. A value of the input mantissa part PI3 is equal to “13”. Therefore, equation (10) may be expressed as equation (11).

$$EXP ( F ) = EXP ( {2}^{( 13 - 15 )} ) * EXP ( {2}^{( 13 - 15 )} * \frac{13}{{2}^{10}} ) = EXP ( {2}^{- 2} ) * EXP ( {2}^{( - 2 )} * \frac{13}{{2}^{10}} ) = B * P \qquad equation ( 11 )$$

The first lookup table 110 may provide the selected first natural exponent value VT1 according to the input exponent part PI2, and take the selected first natural exponent value VT1 as the part “B” in equation (11).

The value of the input mantissa part PI3 is equal to “13”. “13” may be represented as “1+4+8”. Therefore, the part “P” may be expressed by equation (12).

$$P = EXP ( {2}^{( - 2 )} * \frac{13}{{2}^{10}} ) = EXP ( {2}^{( - 2 )} * \frac{( 1 + 4 + 8 )}{{2}^{10}} ) = EXP ( {2}^{( - 2 )} * \frac{1}{{2}^{10}} ) * EXP ( {2}^{( - 2 )} * \frac{4}{{2}^{10}} ) * EXP ( {2}^{( - 2 )} * \frac{8}{{2}^{10}} ) \qquad equation ( 11 )$$

It should be noted that “P” in equation (12) is equal to a product of the selected second natural exponent values VT2_1, VT2_3, and VT2_4 in the second natural exponent values V2_1-V2_b. The selected second natural exponent value VT2_1 corresponding to the 0^{th} bit. The selected second natural exponent value VT2_3 corresponding to the 2^{nd} bit. The selected second natural exponent value VT2_4 corresponding to the 3^{rd} bit. In other words, the second lookup table 120 may select the corresponding selected second natural exponent values from the second natural exponent values V2_1-V2_b according to high logic values of multiple bits of the input mantissa part PI3.

In addition, “x”, “k”, and “EB” are all integer values. In other words, the first lookup table 110 selects the selected first natural exponent value VT1 from the first natural exponent values V1_1-V1_a according to an integer variable. The second lookup table 120 selects at least one selected second natural exponent value from the second natural exponent values V2_1-V2_b according to the integer variable. Therefore, the complexity of the first lookup table 110 and the second lookup table 120 may be reduced.

Therefore, in this example, the second lookup table 120 may provide the selected second natural exponent values VT2_1, VT2_3, VT2_4 (VT2_4 not shown) for implementing the part “P” in equation (12) based on the input exponent part PI2 and the input mantissa part PI3. The second lookup table 120 only stores the second natural exponent values V2_1-V2_b. The second natural exponent values V2_1-V2_b are generated according to a plurality of different powers of a natural constant. The plurality of powers are respectively n powers of 2. The second lookup table 120 does not need to store other natural exponent values. In this way, the circuit design cost and space cost of the second lookup table 120 may be reduced.

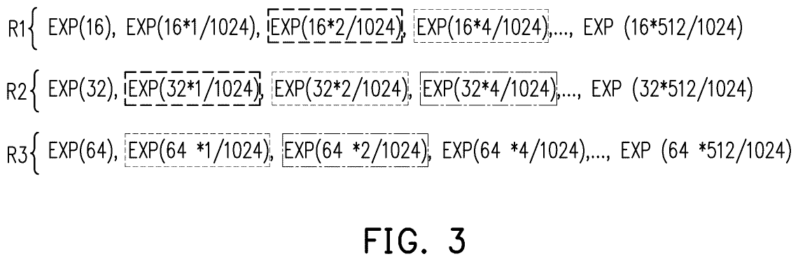

Referring to FIG. 1, FIG. 2 and FIG. 3, FIG. 3 is a schematic diagram of a second natural exponent value according to an embodiment of the invention. FIG. 3 illustrates an array of multiple second natural exponent values. Taking the floating point number format of FP16 as an example (the invention is not limited thereto), “BS” is equal to “15”. In a first row R1 of the array, “EB” equals “19”. In a second row R2 of the array, “EB” equals “20”. In a third row R3 of the array, “EB” equals “21”. It should be noted that the second natural exponent value “EXP(16*2/1024)” in the first row R1 is equal to the second natural exponent value “EXP(32*1/1024)” in the second row R2. The second natural exponent value “EXP(16*4/1024)” in the first row R1 is equal to the second natural exponent value “EXP(32*2/1024)” in the second row R2 and the second natural exponent value in R3 is “EXP(64*1/1024)” in the third row R3. The second natural exponent value “EXP(32*4/1024)” in the second row R2 is equal to the second natural exponent value “EXP(64*2/1024)” in the third row R3. In other words, the plurality of second natural exponent values in the first row R1, the second row R2, and the third row R3 are partially repeated. Therefore, the array shown in FIG. 3 may be simplified. For example, the second row R2 may be omitted. The third row R3 only retains “EXP(64)”, but the invention is not limited thereto. Actually, the second natural exponent value is further reduced. Therefore, the circuit design cost and space cost of the second lookup table 120 may be reduced.

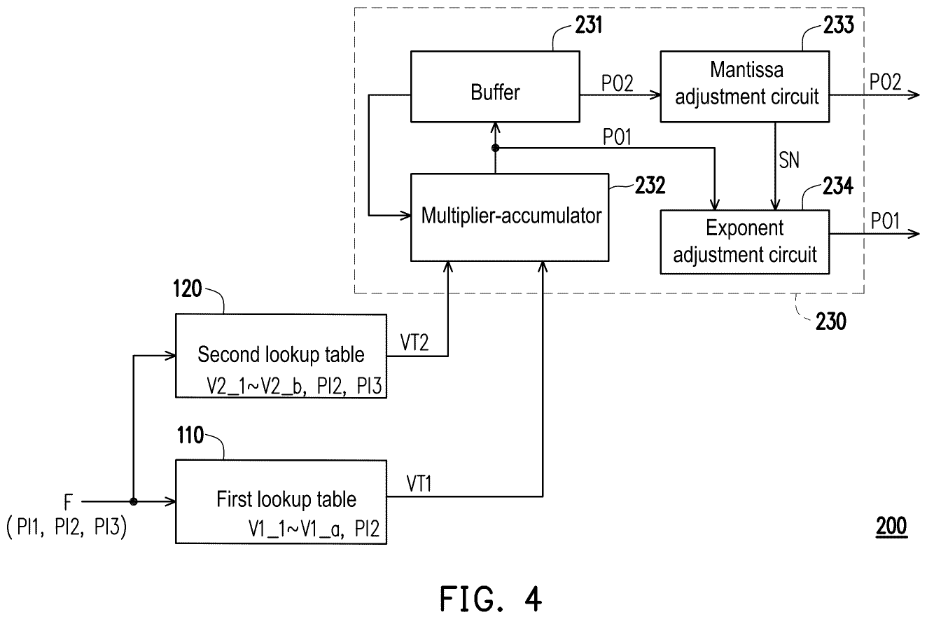

Referring to FIG. 4, FIG. 4 is a schematic diagram of a nature exponential function computing device according to an embodiment of the invention. In the embodiment, the nature exponential function computing device 200 includes the first lookup table 110, the second lookup table 120, and an operation circuit 230. The implementation details of the first lookup table 110 and the second lookup table 120 have been clearly explained in the embodiments of FIG. 1 to FIG. 3, and therefore will not be repeated here. In the embodiment, the operation circuit 230 includes a buffer 231 and a multiplier-accumulator 232. The multiplier-accumulator 232 is coupled to the buffer 231, the first lookup table 110 and the second lookup table 120. The multiplier-accumulator 232 multiplies the selected first natural exponent value VT1 by at least one selected second natural exponent value (collectively referred to as VT2) in an iterative manner to generate the output exponent part PO1 and the output mantissa part PO2, and provides the output exponent part PO1 and the output mantissa part PO2 to the buffer 231.

In the embodiment, the buffer 231 may be implemented by any type of register or memory circuit.

For example, in a first operation loop, the multiplier-accumulator 232 multiplies the selected first natural exponent value VT1 by a first selected second natural exponent value in the at least one selected second natural exponent value VT2 to generate a first product, and provides the first product to buffer 231. The first product includes the output exponent part PO1 and the output mantissa part PO2. In the second operation loop, the multiplier-accumulator 232 multiplies the first product stored in the buffer 231 by a second selected second natural exponent value in the at least one selected second natural exponent value VT2 to generate a second product, and provides the second product to buffer 231. The second product includes the new output exponent part PO1 and the new output mantissa part PO2, and so on.

In the embodiment, based on the floating point number format, the multiplier-accumulator 232 may add a power value of the current output exponent part PO1 with a power value of the exponent part of the selected second natural exponent value VT2 to generate a power value of the new output exponent part PO1. The multiplier-accumulator 232 may multiply a value of the current output mantissa part PO2 by a value of the mantissa part of the selected second natural exponent value VT2 to generate a value of the new output mantissa part PO2. Based on each operation loop, the multiplier-accumulator 232 may perform a bit shift on a power value of the exponent part of the selected second natural exponent value VT2 for the output exponent part PO1 to generate a new value of the output exponent part PO1.

In addition, the operation circuit 230 may determine the value of the output mantissa part PO2. When the value of the output mantissa part PO2 is greater than or equal to 2, the operation circuit 230 divides the value of the output mantissa part PO2 by the m power of 2 so that the value of the output mantissa part PO2 is less than 2 and greater than or equal to 1, and adds m to the power value of the output exponent part PO1, where m is a positive integer.

For example, based on the floating point number format, the selected first natural exponent value VT1 is equal to “1.847264025*2²”, for example. The selected second natural exponent value VT2 is equal to “1.706192189*2⁵”, for example. Therefore, the value of the new output mantissa PO2 is equal to “3.151787449”. The power value of the output exponent part PO1 is equal to “7” (i.e., 2+5). It should be noted that, based on the above example, the value of the output mantissa part PO2 is equal to “3.151787449”. The value of the above output mantissa part PO2 is greater than 2. The above output mantissa part PO2 does not conform to the floating point number format. Therefore, the operation circuit 230 divides the value of the output mantissa part PO2 by 2 raised to the power of 1 (i.e., “m”=1) so that the value of the output mantissa part PO2 is less than 2 and greater than or equal to 1. Therefore, the value of the output mantissa part PO2 is equal to “1.575893725”. The operation circuit 230 adds 1 to the power value of the output exponent part PO1. The power value of the output exponent part PO1 is equal to “8”. Therefore, a product of the selected first natural exponent value VT1 multiplied by the selected second natural exponent value VT2 is equal to “1.575893725*2⁸”. The output exponent part PO1 is a result of multiple exponent bit values conforming to the floating point number format (for example, FP16 or FP32). The output mantissa part PO2 is a result of multiple mantissa bit values conforming to the floating point number format. Taking the floating point number format of FP16 as an example (the invention is not limited thereto), the 15^{th} bit is the output sign part. 10^{th} to 14^{th} bits are the output exponent part PO1. 0^{th} to 9^{th} bits are the output mantissa part PO2.

In the embodiment, the operation circuit 230 further includes a mantissa adjustment circuit 233 and an exponent adjustment circuit 234. The mantissa adjustment circuit 233 is coupled to the buffer 231. The mantissa adjustment circuit 233 receives the output mantissa part PO2 and adjusts the output mantissa part PO2. The exponent adjustment circuit 234 is coupled to the mantissa adjustment circuit 233 and the multiplier-accumulator 232. The exponent adjustment circuit 234 receives the output exponent part PO1 and adjusts the output exponent part PO1.

In the embodiment, the mantissa adjustment circuit 233 determines whether a value of the output mantissa part PO2 is greater than or equal to 2. When the value of the output mantissa part PO2 is greater than or equal to 2, the mantissa adjustment circuit 233 divides the value of the output mantissa part PO2 by the m power of 2 so that the value of the output mantissa part PO2 is less than 2 and greater than or equal to 1, and provides a notification signal SN. The exponent adjustment circuit 234 adds m to the power value of the output exponent part PO1 according to the notification signal SN.

Moreover, when the input value Fis a negative value, the operation result may produce a denormalized value. Therefore, the mantissa adjustment circuit 233 may perform a normalized numerical multiplication operation on the output mantissa part PO2 for converting into a denormalized number.

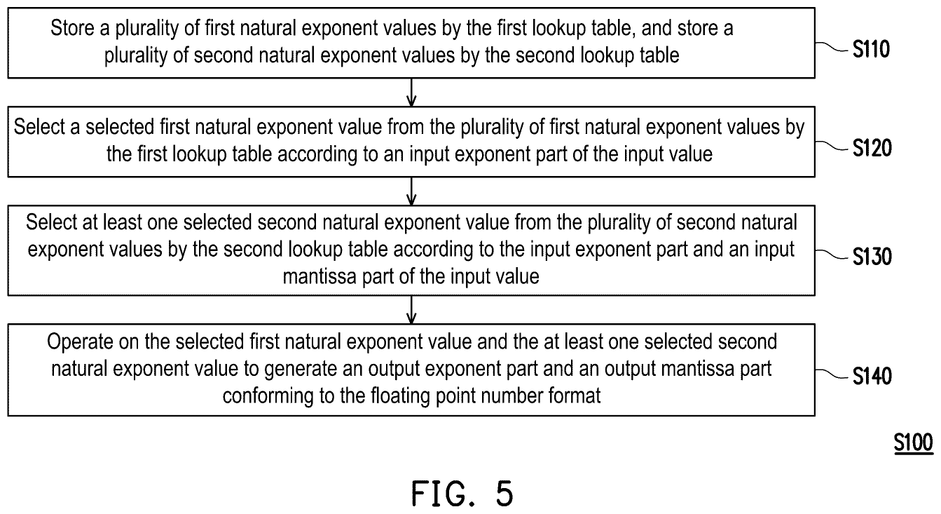

Referring to FIG. 1 and FIG. 5, FIG. 5 is a flowchart of a computing method according to an embodiment of the invention. In the embodiment, a computing method S100 may be applied to the nature exponential function computing device 100. The computing method S100 includes steps S110 to S140. In step S110, the first lookup table 110 stores the first natural exponent values V1_1-V1_a. The second lookup table 120 stores the second natural exponent values V2_1-V2_b.

In step S120, the first lookup table 110 selects the selected first natural exponent value VT1 from the first natural exponent values V1_1-V1_a according to the input exponent part PI2 of the input value F. In step S130, the second lookup table 120 selects at least one selected second natural exponent value (for example, the selected second natural exponent values VT2_1, VT2_2, VT2_3) from the second natural exponent values V2_1-V2_b according to the input exponent part PI2 and the input mantissa part PI3 of the input value F. In some embodiments, steps S120 and S130 may be performed simultaneously. In some embodiments, step S130 may be earlier than step S120.

In step S140, the operation circuit 130 operates on the selected first natural exponent value VT1 and the at least one selected second natural exponent value to generate an output exponent part PO1 and an output mantissa part PO2 conforming to the floating point number format.

The implementation details of steps S110 to S140 have been clearly explained in the embodiments of FIG. 1 to FIG. 3, which will not be repeated here.

In addition, the computing method S100 may be applied to the natural exponential function computing device 200 in FIG. 4.

In summary, the first lookup table stores a plurality of first natural exponent values. The second lookup table stores a plurality of second natural exponent values. The number of the first natural exponent values may be reduced based on the floating point number format. The number of the second natural exponent values may also be reduced based on the floating point number format. Therefore, the requirements on the storage spaces of the first lookup table and the second lookup table are reduced. In this way, the nature exponential function computing device is adapted to reduce a computing time and circuit design cost required to perform the nature exponential function computation. In addition, the first lookup table provides the selected first natural exponent value based on the integer variable. The second lookup table provides at least one selected second natural exponent value based on the integer variable. Therefore, the complexity of the first lookup table and the second lookup table may be reduced.

It will be apparent to those skilled in the art that various modifications and variations can be made to the disclosed embodiments without departing from the scope or spirit of the invention. In view of the foregoing, it is intended that the invention covers modifications and variations provided they fall within the scope of the following claims and their equivalents.

What is claimed is:

1. A nature exponential function computing device, wherein the nature exponential function computing device performs natural exponential function computation on an input value conforming to a floating point number format, wherein the nature exponential function computing device comprises:
a first lookup table, configured to store a plurality of first natural exponent values, and select a selected first natural exponent value from the plurality of first natural exponent values according to an input exponent part of the input value;
a second lookup table, configured to store a plurality of second natural exponent values, and select at least one selected second natural exponent value from the plurality of second natural exponent values according to the input exponent part and an input mantissa part of the input value, wherein the plurality of second natural exponent values are generated according to different powers of a natural constant, wherein the plurality of powers are respectively n powers of 2, wherein n is an integer; and
an operation circuit, coupled to the first lookup table and the second lookup table, and configured to operate on the selected first natural exponent value and the at least one selected second natural exponent value to generate an output exponent part and an output mantissa part conforming to the floating point number format.

2. The nature exponential function computing device as claimed in claim 1, wherein the second lookup table selects the at least one selected second natural exponent value from the second natural exponent values based on high logic values of a plurality of bits of the input mantissa part.

3. The nature exponential function computing device as claimed in claim 1, wherein when a value of the output mantissa part is greater than or equal to 2, the operation circuit divides the value of the output mantissa part by an m power of 2 to make the value of the output mantissa part to be less than 2 and greater than or equal to 1, and adds m to a power of the output exponent part, wherein m is a positive integer.

4. The nature exponential function computing device as claimed in claim 1, wherein the operation circuit multiplies the selected first natural exponent value and the at least one selected second natural exponent value to generate the output exponent part and the output mantissa part.

5. The nature exponential function computing device as claimed in claim 1, wherein the operation circuit comprises:
a buffer; and
a multiplier-accumulator, coupled to the buffer, the first lookup table, and the second lookup table, configured to multiply the selected first natural exponent value by one of the at least one selected second natural exponent value in an iterative manner to generate the output exponent part and the output mantissa part, and providing the output exponent part and the output mantissa part to the buffer.

6. The nature exponential function computing device as claimed in claim 5, wherein the multiplier-accumulator multiplies the selected first natural exponent value by a first selected second natural exponent value in the at least one selected second natural exponent value to generate a first product, provides the first product to the buffer, multiplies the first product stored in the buffer by a second selected second natural exponent value in the at least one selected second natural exponent value to generate a second product, and provides the second product to the buffer.

7. The nature exponential function computing device as claimed in claim 5, wherein the operation circuit further comprises:
a mantissa adjustment circuit, coupled to the buffer, configured to receive the output mantissa part, and adjusting the output mantissa part; and
an exponent adjustment circuit, coupled to the mantissa adjustment circuit and the multiplier-accumulator, configured to receive the output exponent part, and adjusting the output exponent part.

8. The nature exponential function computing device as claimed in claim 7, wherein:
when the mantissa adjustment circuit determines whether a value of the output mantissa part is greater than or equal to 2,
when the value of the output mantissa part is greater than or equal to 2, the mantissa adjustment circuit divides the value of the output mantissa part by an m power of 2 to make the value of the output mantissa part to be less than 2 and greater than or equal to 1, and provides a notification signal, and
the exponent adjustment circuit adds m to a power of the output exponent part according to the notification signal, wherein m is a positive integer.

9. A computing method adapted to a nature exponential function computing device, wherein the nature exponential function computing device performs natural exponential function computation on an input value conforming to a floating point number format, wherein the nature exponential function computing device comprises a first lookup table, a second lookup table, and an operation circuit, wherein the computing method comprises:
storing a plurality of first natural exponent values by the first lookup table, and storing a plurality of second natural exponent values by the second lookup table;
selecting a selected first natural exponent value from the plurality of first natural exponent values by the first lookup table according to an input exponent part of the input value;
selecting at least one selected second natural exponent value from the plurality of second natural exponent values by the second lookup table according to the input exponent part and an input mantissa part of the input value, wherein the plurality of second natural exponent values are generated according to different powers of a natural constant, wherein the plurality of powers are respectively n powers of 2, wherein n is an integer; and
operating on the selected first natural exponent value and the at least one selected second natural exponent value by the operation circuit to generate an output exponent part and an output mantissa part conforming to the floating point number format.

10. The computing method as claimed in claim 9, wherein the step of selecting the at least one selected second natural exponent value from the plurality of second natural exponent values by the second lookup table according to the input exponent part and the input mantissa part of the input value comprises:
selecting the at least one selected second natural exponent value from the second natural exponent values based on high logic values of a plurality of bits of the input mantissa part.

11. The computing method as claimed in claim 9, further comprising:
when a value of the output mantissa part is greater than or equal to 2, dividing the output mantissa part by an m power of 2 by the operation circuit to make the output mantissa part to be less than 2 and greater than or equal to 1, and adding m to a power of the output exponent part, wherein m is a positive integer.

12. The computing method as claimed in claim 9, wherein the step of operating on the selected first natural exponent value and the at least one selected second natural exponent value by the operation circuit to generate the output exponent part and the output mantissa part conforming to the floating point number format comprises:
multiplying the selected first natural exponent value and the at least one selected second natural exponent value to generate the output exponent part and the output mantissa part.

13. The computing method as claimed in claim 12, wherein the step of multiplying the selected first natural exponent value and the at least one selected second natural exponent value to generate the output exponent part and the output mantissa part comprises:
multiplying the selected first natural exponent value by one of the at least one selected second natural exponent value in an iterative manner to generate the output exponent part and the output mantissa part.
